(19) United States
(12) Patent Application Publication
(10) Pub. No.: US 2002/0035725 A1
(43) Pub. Date: Mar. 21, 2002

(54) Multimedia data transmitting apparatus and method, multimedia data receiving apparatus and method, multimedia data transmission system, and storage medium

(76) Inventor: Tsutomu Ando, Kanagawa (JP)

Correspondence Address: MORGAN & FINNEGAN, L.L.P., 345 PARK AVENUE, NEW YORK, NY, 10154, US

(21) Appl. No.: 09/948,482

(22) Filed: Sep. 7, 2001

(30) Foreign Application Priority Data
Sep. 8, 2000 (JP) 2000-273559
Sep. 8, 2000 (JP) 2000-273905

(51) Int. Cl. H04N 7/10

(52) U.S. Cl. 725/32

(57) ABSTRACT

This invention makes multimedia transmission possible while maintaining the safety of information requiring security. The transmitting side transmits multimedia data which is composed of a plurality of objects and to which Intellectual Property protection information is added. A session managing unit is placed between the transmitting side and the receiving side. This session managing unit demultiplexes the multimedia data as an output stream from the transmitting side into Intellectual Property protection data and unprotected protection data, and manages a non-secure session for transmitting the unprotected protection data and a secure session for transmitting the Intellectual Property protection data.

### FIELD OF THE INVENTION

The present invention relates to the transmission of multimedia data containing intellectual property (e.g., copyright) protection management data.

### BACKGROUND OF THE INVENTION

Presently, the standardization of multimedia coding (compression format) is being advanced by ISO/IEC 14496 (MPEG Phase 4). This standard can encode conventional video-audio data and can also define the spatial-temporal arrangement of each medium. This is called scene description. Also, each medium is called an object.

FIG. 3 shows an example of a scene. In this example, a box 301, a cylinder 302, an image texture 301a pasted on the box 301, and a video texture 302a pasted on the cylinder 302 are defined as graphic objects. Audio 303 to be reproduced simultaneously with these graphic objects is also defined.

As a method of the scene description itself, BIFS (BInary Format for Scene description) which performs function extension and binarization on the basis of VRML (Virtual Reality Markup Language) is used. The binarization scheme of this BIFS will be omitted.

Independent of this scene description, data called an object descriptor (to be referred to as an OD hereinafter) which indicates the attributes of each object is added. Examples of the attributes are the attribute (e.g., video, audio, or image) of a medium, intellectual property (e.g., copyright) holder information, QOS (Quality Of Service) information, and contents rating information. Each of these attributes is contained as one descriptor in the OD.

FIG. 4 shows an example of a whole bitstream.

An initial bitstream 401 stores the property (e.g., the bitstream profile) of the whole bitstream. A BIFS stream 402 stores scene information.

ODs 403 and 406 describe the attributes of the subsequent objects. This example includes two ODs (OD1 and OD2). Following these OD1 (403) and OD2 (406), a plurality of elementary stream descriptors (to be referred to as ESDs hereinafter) indicating the attributes of media streams (called elementary streams) ES1 and ES2 can be described. Referring to FIG. 4, ESD1 (404) is described after OD1 (403), and ESD2 (407) is described after OD2 (406).

In practice, these elementary streams ES1 and ES2 are packetized and handled as sync layer packets (to be referred to as SL packets hereinafter). As shown in FIG. 4, therefore, SLConfig descriptors 405 and 408 which describe the structure of an SL packet are added to ESD1 (404) and ESD2 (407), respectively.

In the bitstream shown in FIG. 4, the descriptors, i.e., ODs and ESDs described above must be placed in the header before the elementary streams ES1 and ES2. However, each of these ODs and ESDs can be added, deleted, or changed by inserting an update command in the middle of the bitstream.

According to the standard, intellectual property (e.g., copyright) management information and access control information can be added to each OD or ES. These pieces of information are called IPMP (Intellectual Property Management and Protection) information. The details of this IPMP information itself are described by a descriptor called an IPMP descriptor. In practice, encryption technologies are often used in access control.

An IPMP system (descriptor syntax) is not specified, i.e., it is a free syntax. However, only an IPMP system type number registered in RA (Registration Authority) is described.

An ES for IPMP (IPMP_ES) can be added to IPMP information described by an IPMP descriptor by linking using an ID.

FIG. 5 shows an example of the whole of this bitstream. Referring to FIG. 5, IPMP1 (409) and IPMP2 (411) are IPMP_ES for ES1 (410) and ES2 (412), respectively. This example is a stream containing one command 413 for updating IPMP information.

FIG. 6 shows details of the IPMP descriptor. Referring to FIG. 6, a descriptor tag (TAG) 601 indicates the type of descriptor. A length field (LENGTH) 602 indicates the length (the number of bytes) of the whole descriptor. A descriptor ID 603 stores a unique identifier in a bitstream of the descriptor itself. IPMPS_type 604 indicates a system type number as described above. In an option field (Option) 605, data attached to IPMP can be properly inserted. The syntax in this field 605 is a free syntax. Note that the attached data can also be shown to the outside as a URL in this field 605.

In the bitstream shown in FIG. 5, the IPMP descriptor described above must also be placed in the header before the elementary streams ES1 and ES2.

FIG. 7 shows an example of a system encoder for generating these bitstreams.

Referring to FIG. 7, an object descriptor generator 701 appropriately generates descriptors as described above in accordance with the property of a bitstream. Media encoders 702 actually encode video and audio data.

A BIFS encoder 704 binarizes scene information. An update controller 705 inserts, where necessary, commands for updating the properties of an OD, ESD, and IPMP descriptor. However, this update controller 705 is not an essential function. A multiplexer 706 finally multiplexes the above-mentioned descriptors and media streams into one SL packet.

FIG. 8 shows the arrangement of a decoder (reconstructor). Referring to FIG. 8, a demultiplexer 801 separates individual descriptors, ESs, and the like. A descriptor parser (analyzer) 803 discriminates the type of descriptor in accordance with tag information, interprets the contents of each descriptor, and properly sets in each unit. A BIFS decoder 804 decodes a binarized BIFS stream to reconstruct a scene structure. A media decoder 805 actually decodes media data such as video, audio, and image data.

A renderer 807 is a mechanism which appropriately displays and reproduces each object in accordance with a scene structure. An IPMP controller 806 performs media reproduction control (e.g., reproduction limitation and effect control) in accordance with the information of an IPMP descriptor and IPMP_ES. For example, if data is encrypted, the IPMP controller 806 decrypts the data and transfers the decrypted data to the media decoder.

A sync controller 802 performs sync control between individual media. A method of data transfer from the encoder shown in FIG. 7 to the decoder (reconstructor) shown in FIG. 8 is not specifically described. In transmission on a network, however, data is generally transmitted and received as one bitstream by the same session.

On the other hand, ISO/IEC 14496-6 defines an API (Application Programming Interface) for communication of a network between a terminal called DMIF and an application, or between terminals.

FIG. 11 shows an example of this API. Reference numeral 1101 denotes an interface for additionally setting up a new channel from an application; 1102, a channel setup interface between network terminals; and 1103, an API for actually setting up a communication protocol and the like on a network.

Referring to FIG. 11, serviceSessionId is an identifier of a session to which a channel is to be added. qosDescriptor is a descriptor indicating the QOS (Quality Of Service) of a channel. “direction” indicates a communication direction; uuDataInBuffer( ), a buffer for storing additional information; and uuDataInLen, the data length of the buffer. As response information, “response” indicates the possibility of channel setup, channelHandle returns the handle of a setup channel, uuDataOutBuffer( ) sends additional information, and ddDataOutLen returns the data length of the buffer. In this way, an API for setting up a channel regardless of a transmission protocol and a setup procedure is defined. The other individual parameters have no relationship to the present invention, so a detailed description thereof will be omitted.

FIG. 15 shows an inter-terminal channel setup procedure using this API.

An application issues a channel addition request by using a DA_ChannelAdd( ) command. After that, setup on a network is performed by a DN_TransMuxSetup( ) command. DN_ChannelAddedo actually sets up a channel between transmitting and receiving terminals.

In the standard, only minimum necessary parameters (e.g., the relationship between a session and a channel, transmission direction, and QOS information) are defined. However, various other parameters must also be transmitted in practice.

FIG. 13 shows an example of this data set.

DsmccMessageHeader is the header of a message. NetworkSessionID indicates an identifier of a session. ServiceID indicates an identifier for service in an upper layer. Count indicates the number of channels to be added. Data is repeated by this number of channels, and the message of data of each session is transmitted.

Unfortunately, these conventional examples have the following problems.

In the example shown in FIG. 6, the IPMP descriptor is a free syntax, so no compatibility can be obtained between two or more IPMP systems. Also, if the syntax of this IPMP descriptor is clearly standardized, the security system is disclosed, and this lowers the security level.

Furthermore, as shown in FIG. 9, when IPMP descriptors (packets) are transmitted on a network, the data is peeped on the network, and so the security can no longer be warranted. A multiplexer 901 multiplexes each stream in accordance with individual steps (a sync layer: SL, a variable-length packet generator: FlexMux (described as Flex in FIG. 9), and a network transmission packet generator: TransMux (described as Trans in FIG. 9)), thereby finally generating one bitstream 902. Referring to FIG. 9, AVO represents Audio Visual Object; and Desc., various descriptors.

### SUMMARY OF THE INVENTION

The present invention has been made in consideration of the above problems, and has as its object to provide a multimedia data transmitting apparatus and method, multimedia data receiving apparatus and method, multimedia data transmission system, and storage medium, which in the transmission of multimedia data containing an object of intellectual property (copyright) protection, can increase the safety of this object of intellectual property protection.

A multimedia data transmitting apparatus (method) as an invention for achieving the above object is a multimedia data transmitting apparatus (method) for transmitting multimedia data composed of a plurality of objects, characterized by comprising input means (step) for inputting, as a bitstream, multimedia data to which intellectual property protection management data is added, demultiplexing means (step) for demultiplexing the multimedia data of the input bitstream into the intellectual property protection management data and other media data, link information updating means (step) for updating link information for linking the intellectual property protection management data and the media data, and session managing means (step) for managing a non-secure session for transmitting the media data and a secure session for transmitting the intellectual property protection management data.

A multimedia data transmitting apparatus (method) as an invention for achieving the above object is a multimedia data transmitting apparatus (method) for transmitting multimedia data composed of a plurality of objects, comprising input means (step) for inputting multimedia data and intellectual property protection management data for protecting and managing the intellectual property of the multimedia data, and session managing means (step) for managing a non-secure session for transmitting the multimedia data and a secure session for transmitting the intellectual property protection management data.

A storage medium as an invention for achieving the above object is characterized by storing program codes corresponding to the individual steps of the above transmitting method.

A multimedia data receiving apparatus (method) as an invention for achieving the above object is a multimedia data receiving apparatus (method) for receiving multimedia data, comprising first receiving means (step) for receiving media data by a non-secure session, second receiving means (step) for receiving, by a secure session, intellectual property protection management data for protecting and managing an intellectual property with respect to the media data, session managing means (step) for managing the non-secure session and the secure session, first processing means (step) for demultiplexing media data, which is received by the session managing means via the non-secure session, into media streams, and decoding the media streams, second processing means (step) for decoding intellectual property protection management data received by the session managing means via the secure session, and reproducing means (step) for performing reproduction on the basis of the data decoded by the first and second processing means.

A storage medium as an invention for achieving the above object is characterized by storing program codes corresponding to the individual steps of the above receiving method.

A multimedia data transmission system as an invention for achieving the above object is a multimedia data transmission system for transmitting multimedia data composed of a plurality of objects, comprising input means for inputting, as a bitstream, multimedia data to which intellectual property protection management data is added, demultiplexing means for demultiplexing the multimedia data of the input bitstream into the intellectual property protection management data and other media data, link information updating means for updating link information for linking the intellectual property protection management data and the media data, session managing means for managing a non-secure session for transmitting the media data and a secure session for transmitting the intellectual property protection management data, first processing means for demultiplexing media data, which is transmitted via the non-secure session, into media streams, and decoding the media streams, second processing means for decoding intellectual property protection management data received via the secure session, and reproducing means for performing reproduction on the basis of the data decoded by the first and second processing means.

A multimedia data transmission system as an invention for achieving the above object is a multimedia data transmission system for transmitting multimedia data composed of a plurality of objects, comprising input means for inputting multimedia data and intellectual property protection management data for protecting and managing the intellectual property of the media data, session managing means for managing a non-secure session for transmitting the media data and a secure session for transmitting the intellectual property protection management data, first processing means for demultiplexing media data, which is transmitted via the non-secure session, into media streams, and decoding the media streams, second processing means for decoding intellectual property protection management data received via the secure session, and reproducing means for performing reproduction on the basis of the data decoded by the first and second processing means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a system configuration view according to an embodiment;

FIG. 2 is a system configuration view according to the second embodiment;

FIG. 3 is a view showing an example of the result of rendering;

FIG. 4 is a view showing an example of the structure of a bitstream;

FIG. 5 is a view showing an example of the structure of a bitstream;

FIG. 6 is a view showing the structure of an IPMP descriptor;

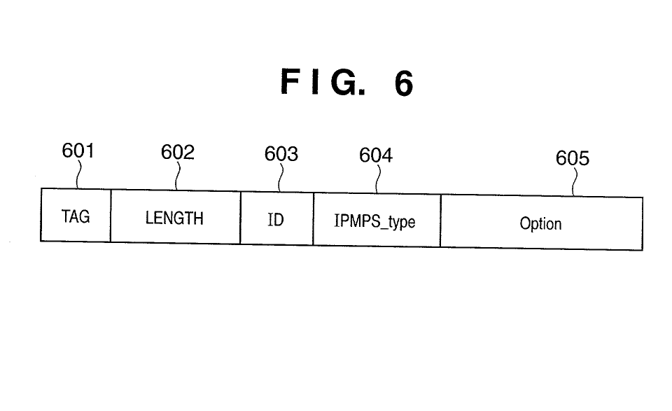

FIG. 7 is a view showing a conventional encoder section;

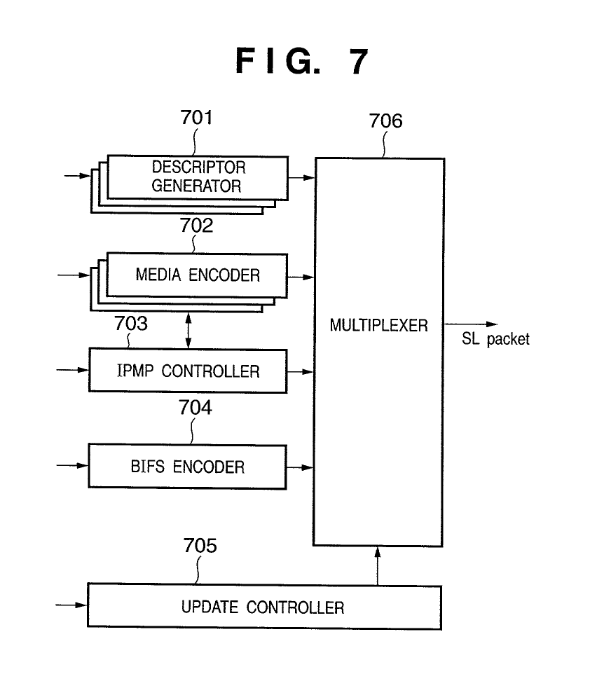

FIG. 8 is a view showing a conventional decoder section;

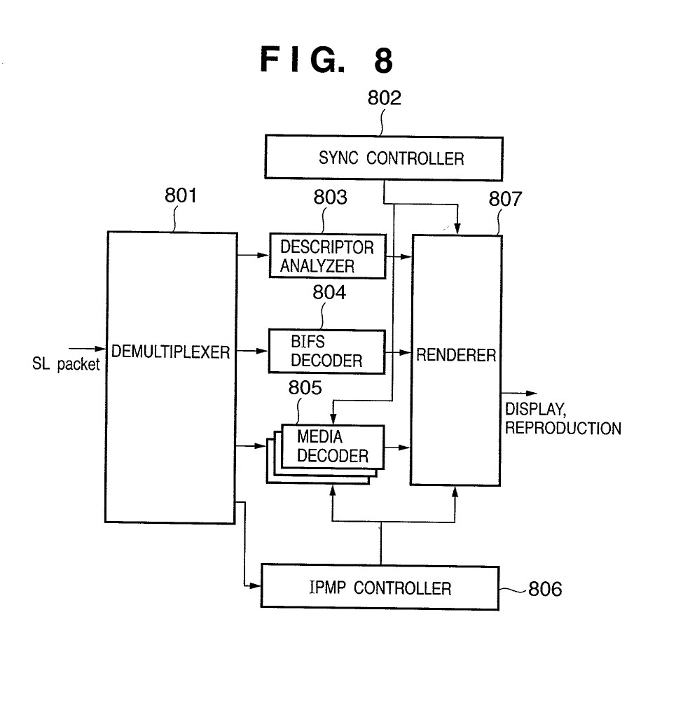

FIG. 9 is a view showing an example of conventional stream transmission;

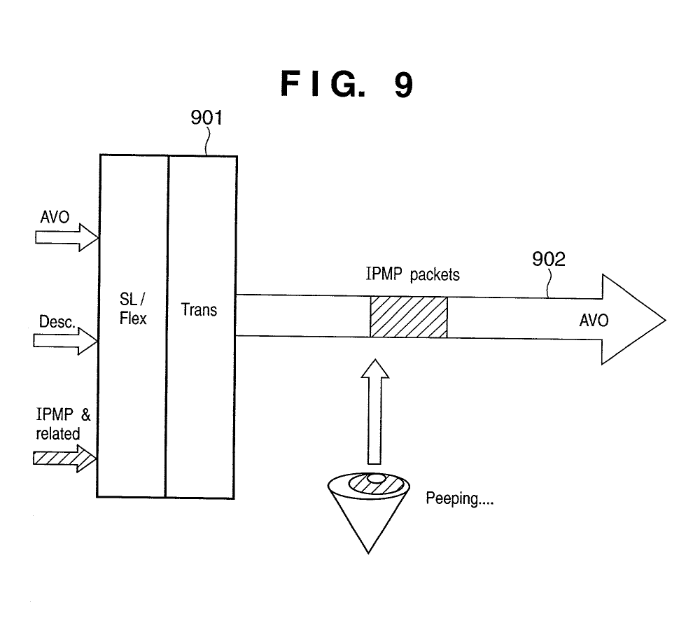

FIG. 10 is a view showing an example of stream transmission according to an embodiment;

FIG. 11 is a view showing the structure of a conventional channel setup API;

FIG. 12 is a view showing the structure of a channel setup API according to an embodiment;

FIG. 13 is a view showing the syntax of a conventional channel setup message;

FIG. 14 is a view showing the syntax of a channel setup message according to an embodiment;

FIG. 15 is a view showing conventional channel setup transactions;

FIG. 16 is a view showing channel setup transactions according to an embodiment;

FIG. 17 is a block diagram showing the arrangement of a data transmission system to which the present invention is applied according to the third embodiment;

FIG. 18 is a block diagram showing the arrangement of a data transmission system to which the present invention is applied according to the fourth embodiment; and

FIG. 19 is a block diagram showing an example of the configuration of a computer for executing a process program for practicing functions of the data transmission systems according to the third and fourth embodiments.

### DETAILED DESCRIPTION OF THE PREFERRED EMBODIMENTS

Preferred embodiments of the present invention will now be described in detail in accordance with the accompanying drawings.

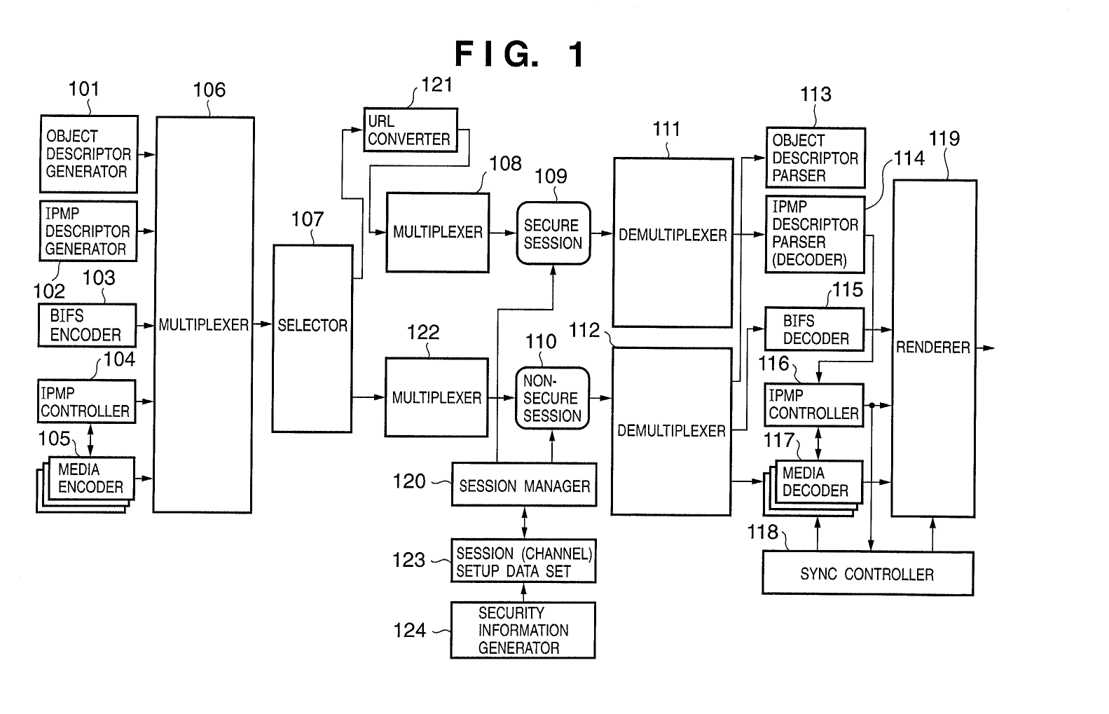

FIG. 1 is a system configuration view according to the first embodiment.

Referring to FIG. 1, an object descriptor (OD) generator 101 codes attribute information of media data to be processed by media encoders 105, thereby generating various ODs. An IPMP descriptor generator 102 codes media data to be processed by the media encoders 105 and codes intellectual property protection information, such as copyright information and reproduction conditions, of scene information to be processed by a BIFS encoder 103, thereby generating descriptors (an IPMP descriptor and IPMP_ES) concerning IPMP from the coded data. The BIFS encoder 103 generates scene information.

The media encoders 105 encode media data such as video and audio data. An IPMP controller 104 properly encrypts an output bitstream from a media encoder, and generates key data necessary for encryption. The method of processing IPMP is not restricted to encryption.

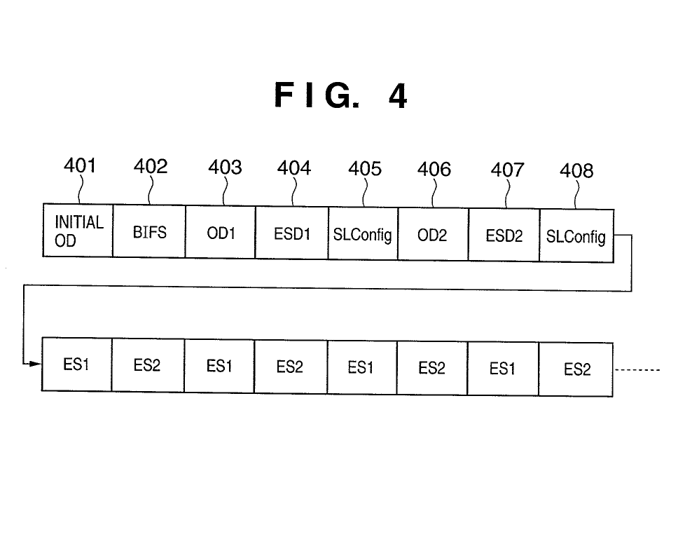

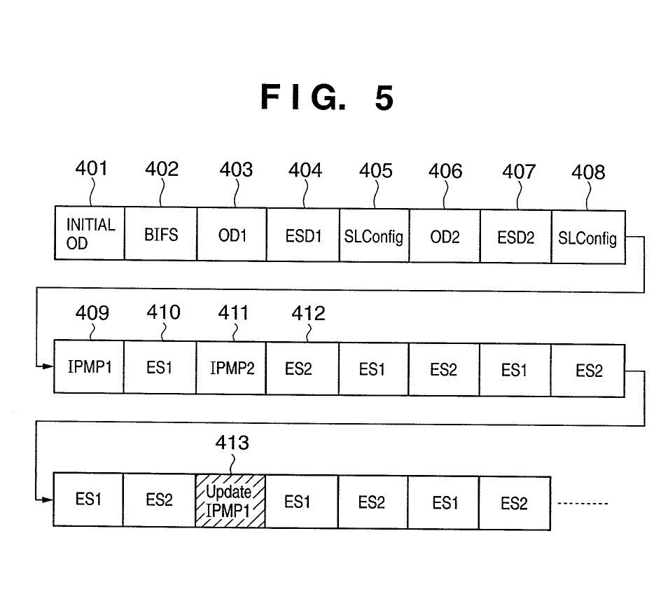

A multiplexer 106 multiplexes the outputs from the OD generator 101, the IPMP descriptor generator 102, the BIFS encoder 103, the IPMP controller 104, and the media encoders 105, thereby forming one bitstream as shown in FIG. 4 or 5. At the same time, the multiplexer 106 performs sync control between individual media. More specifically, the multiplexer 106 embeds a type stamp or clock reference in a packet. This completes a packetized bitstream.

A method of transmitting this bitstream across a network will be explained below.

A selector (demultiplexer) 107 again demultiplexes the output bitstream from the multiplexer 106 into, e.g., a security bitstream (IPMP data) concerning security, such as an IPMP descriptor and IPMP_ES, and the other bitstream (media bitstream such as video and audio). A session manager 120 sets up a session (or channel) optimum for the transmitting side or the receiving side. Although only one session manager 120 is shown in FIG. 1, both the transmitting side and the receiving side have the session manager 120.

A session (channel) message data set 123 stores the corresponding session (channel) setup information. A security information generator 124 stores security information for setting up a session (channel), and determines whether each session (channel) requires a secure connection.

A URL converter 121 performs processing corresponding to that change in the link connection between a media bitstream and a security bitstream, which occurs because the selector 107 demultiplexed the bitstream again. More specifically, in one bitstream, a media bitstream and IPMP data are linked by an ID (i.e., a unique integral number in the bitstream). Since these two streams are separated, the ID portion is replaced with a URL string. A method of describing this URL is separately standardized. Although the method is not described in detail in this specification, the URL can be indicated by a media bitstream or the transmission channel number of IPMP data.

A multiplexer 108 again packetizes, where necessary, the bitstream concerning security in accordance with conversion information of the URL. A multiplexer 122 again packetizes, if necessary, the multimedia bitstream obtained by the selector 107.

The security bitstream is transmitted by a secure session 109.

On the other hand, a common multimedia (A/V (Audio/Video)) bitstream is transmitted by a non-secure session 110. Since, however, this bitstream is already encrypted, it is not peeked on the network.

A demultiplexer 111 demultiplexes the IPMP descriptor and IPMP_ES from the security bitstream transmitted from the secure session 109. A demultiplexer 112 demultiplexes the OD, BIFS, and A/V (Audio/Video) bitstream from the multimedia bitstream transmitted from the non-secure session 110.

An OD parser 113 extracts the OD information from the OD bitstream obtained by the demultiplexer 112 and sets each information necessary for the decoder. An IPMP descriptor parser 114 decodes the IPMP descriptor and IPMP_ES from the security bitstream obtained by the demultiplexer 111. A BIFS decoder 115 decodes the BIFS bitstream obtained by the demultiplexer 12 and reconstructs the scene information. An IPMP controller 116 controls a media decoder 117 or a renderer 119 (e.g., restricts media reproduction and performs effect control) on the basis of the IPMP descriptor and IPMP_ES (intellectual property management information) decoded by the IPMP descriptor parser 114. More specifically, the IPMP controller 116 drives the media decoder only when an encrypted data is decrypted, or extracts watermark information from the decoded image and uses the information in reproduction control. The media decoder 117 decodes the A/V stream (the media stream of image, video, and audio) obtained by the demultiplexer 112. A sync controller 118 synchronizes various media.

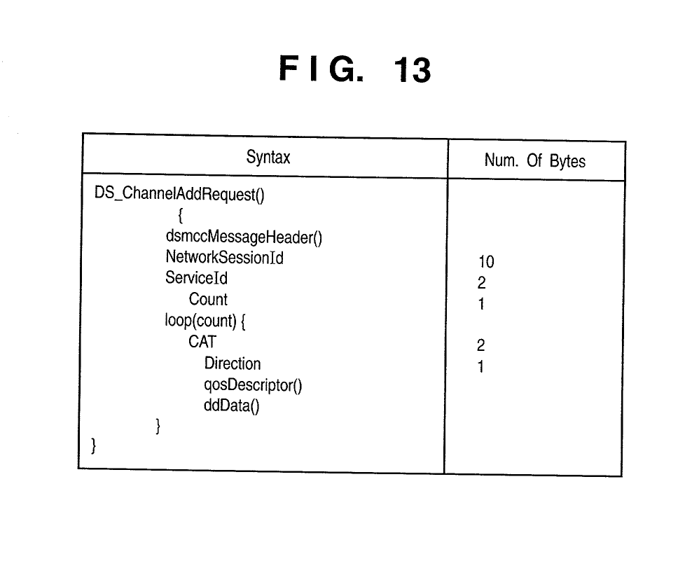

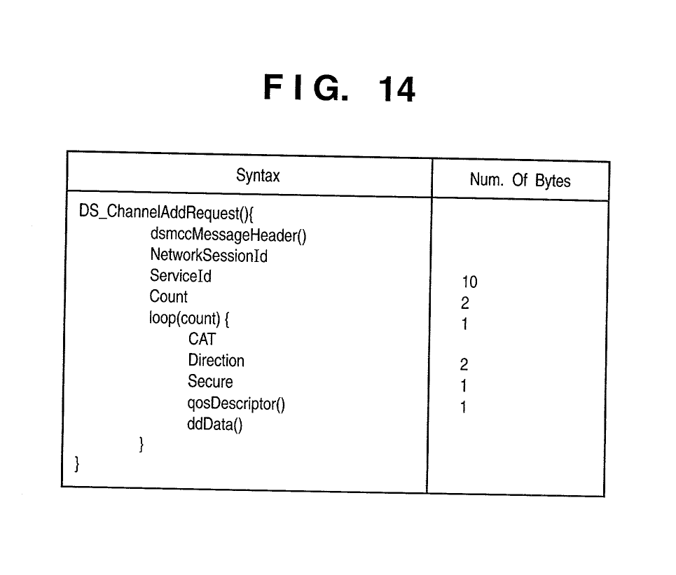

FIG. 14 shows an example of message data of the present invention. The difference from FIG. 13 is that Secure data (1 byte) is inserted in the loop. Whether each channel is secure is checked by this 1-byte data.

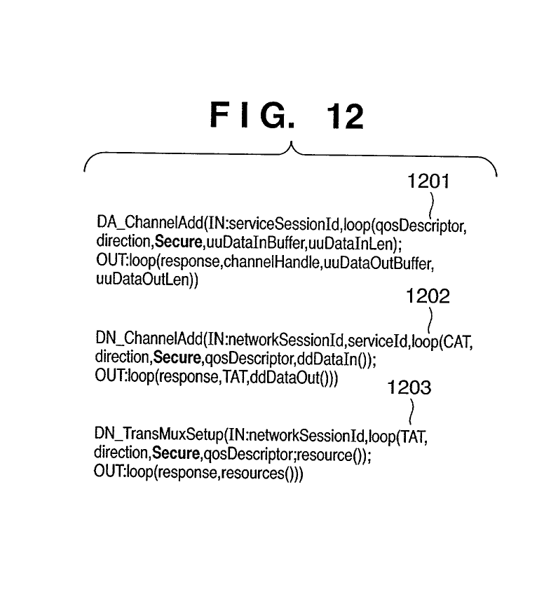

FIG. 12 shows an example of this API. Reference numeral 1201 denotes an interface for additionally setting up a new channel from an application; 1202, a channel setup interface between network terminals; and 1203, an API for setting up an actual communication protocol and the like on a network.

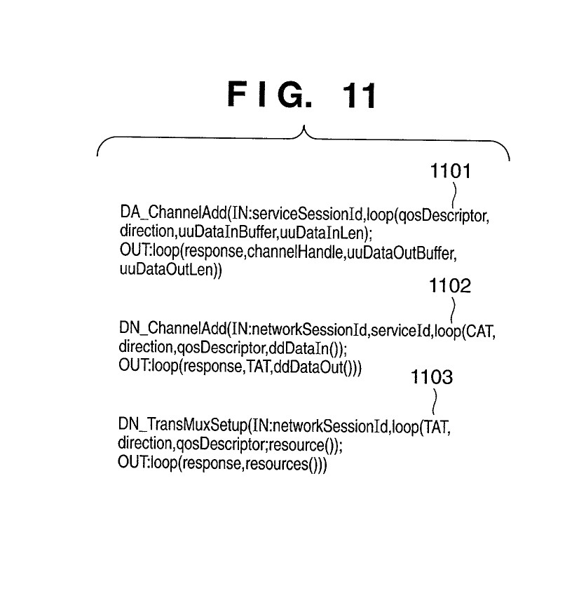

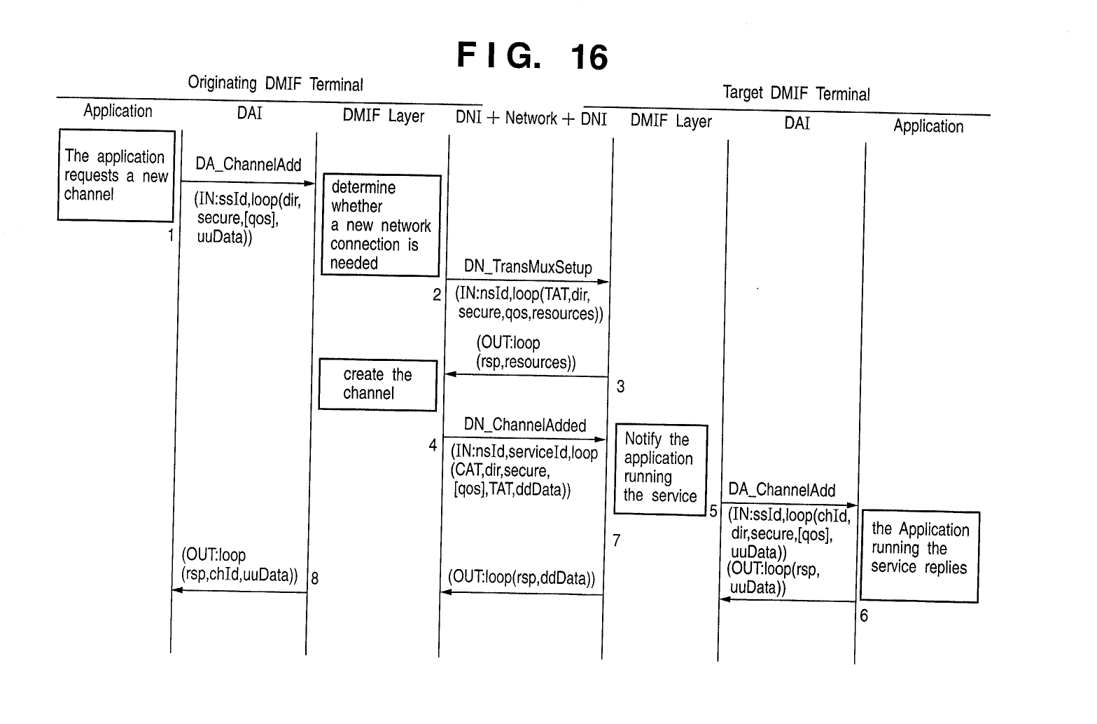

The difference from FIG. 11 as prior art is that Secure as data for checking whether each channel is secure is contained as described above. FIG. 16 shows transactions between terminals according to the present invention.

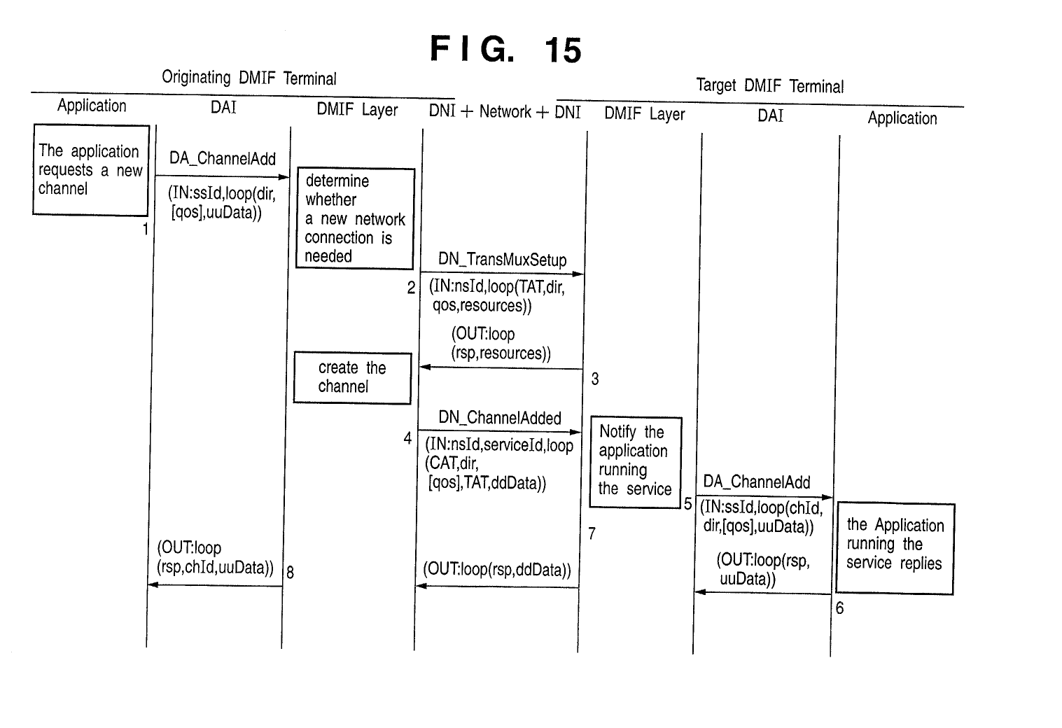

The difference from FIG. 15 as prior art is that the Secure data shown in FIG. 14 is added as a parameter of each API, i.e., each of DA_ChannelAdd( ), DN_TransMuxSetup( ), and DN_ChannelAdded( ).

The characteristic feature of the arrangement as described above is that security information is again extracted and transmitted by a secure session (or channel), so there is no danger of this security information being peeped.

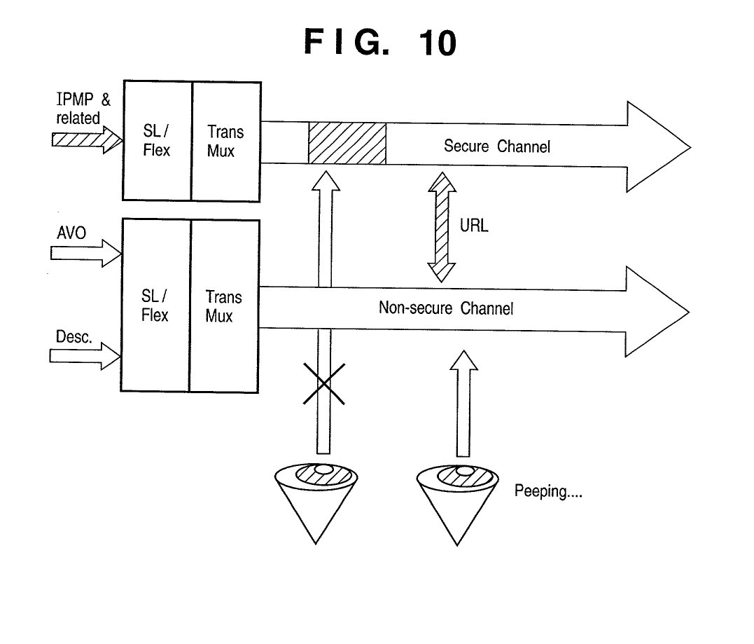

This is shown in FIG. 10. FIG. 10 indicates that the security information is transmitted by a secure session (or channel) and hence cannot be peeped.

Accordingly, even when the syntax of an IPMP descriptor and IPMP_ES is defined, the compatibility can be maintained without lowering the security level.

Note that most of the arrangement shown in FIG. 1 is implemented by software. Also, the session manager 120, the session setup data set 123, and the security information generator 124 shown in FIG. 1 are arranged on both the transmitting side and the receiving side.

<Second Embodiment>

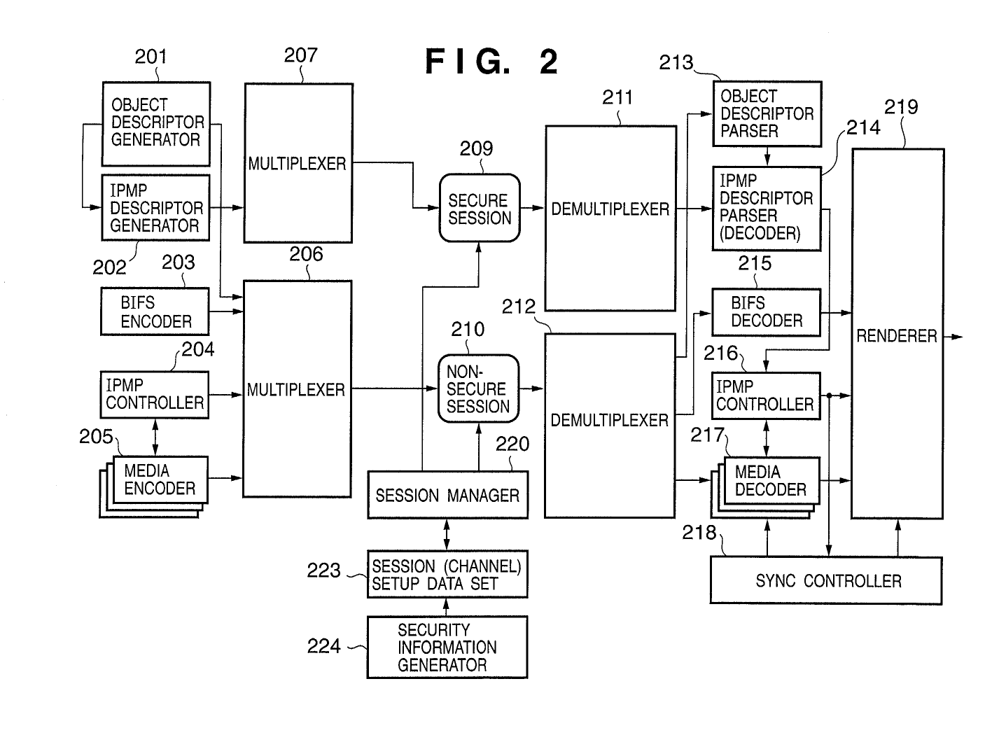

A system configuration according to the second embodiment will be described below with reference to FIG. 2. The same reference numerals as in FIG. 1 denote parts having the same functions in FIG. 2, and a detailed description thereof will be omitted.

In this embodiment, two multiplexers 206 and 207 separately multiplex an IPMP descriptor and IPMP_ES obtained by an IPMP descriptor generator 202, and data (media data) obtained by an OD generator 201, a BIFS encoder 203, an IPMP controller 204, and a media encoder 205. That is, security data is not initially multiplexed but is saved as a different file.

Accordingly, the selector 107, the multiplexers 108 and 122, and the URL converter 121 shown in FIG. 1 are unnecessary, i.e., it is unnecessary to again demultiplex a security bitstream which is to be secure and a normal media bitstream.

In this case, as in the first embodiment, information of each session (channel) is stored in a message data set 223.

In each of the embodiments shown in FIGS. 1 and 2, the renderer 119 (or 219) should start reproduction or display after security information is transmitted by taking synchronization between sessions.

In the first and second embodiments as described above, multimedia transmission can be performed while the safety of information requiring security is maintained.

<Third Embodiment>

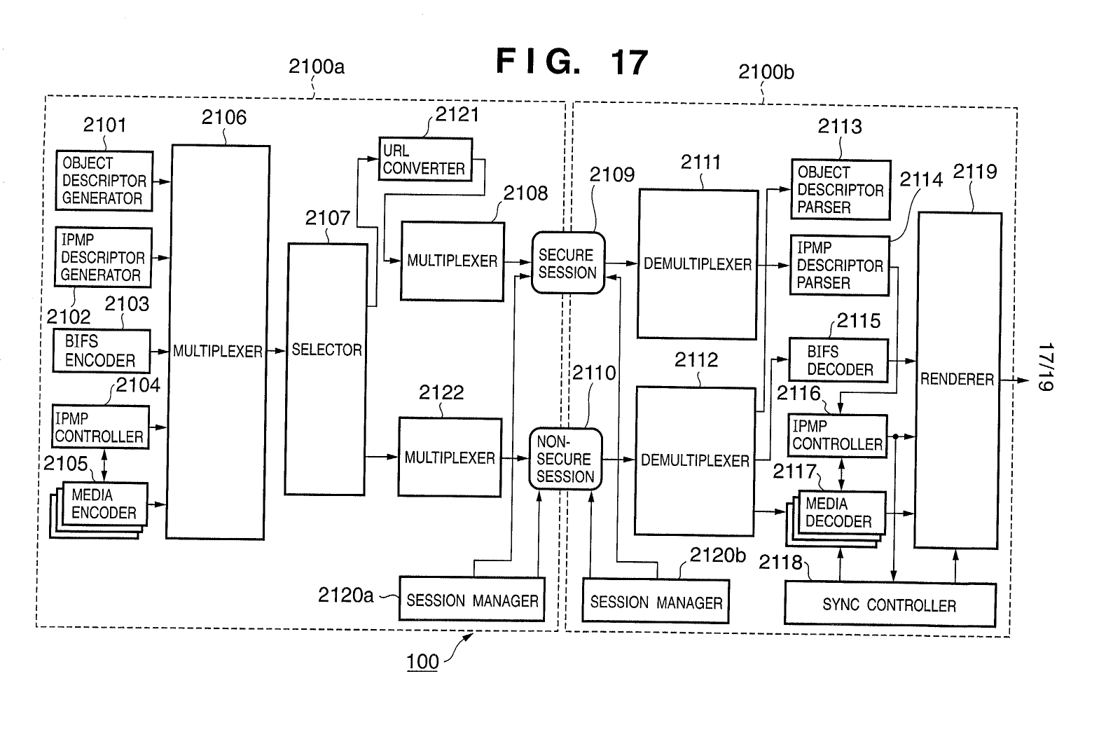

For example, the present invention is applied to a data transmission system 2100 as shown in FIG. 17.

The data transmission system 2100 of this embodiment is based on the “ISO/IEC 14496 (MPEG phase 4)” standard and includes an encoder 2100a and a decoder 2100b having arrangements as shown in FIG. 17.

The encoder 2100a includes an OD generator 2101, an IPMP descriptor generator 2102, a BIFS encoder 2103, an IPMP controller 2104, media encoders 2105, a multiplexer 2106, a selector (demultiplexer) 2107, a multiplexer 2108, a session manager 2120a, a URL converter 2121, and a multiplexer 2122.

The decoder 2100b includes demultiplexers 2111 and 2112, an OD parser 2113, an IPMP descriptor parser (decoder) 2114, a BIFS decoder 2115, an IPMP controller 2116, media decoders 2117, a sync controller 2118, a session manager 2120b, and a renderer 2119.

The encoder 2100a and the decoder 2100b have a session which is secure (to be referred to as a “secure session” hereinafter) and a session which is not secure (to be referred to as a “non-secure session” hereinafter), both of which can be accessed by both of them.

In the encoder 2100a, the media encoders 2105 encode (compress) and output media data such as image, video, audio, and some other multimedia.

The OD generator 2101 encodes attribute information of media data to be processed by the media encoders 2105, and outputs the encoded data as an OD.

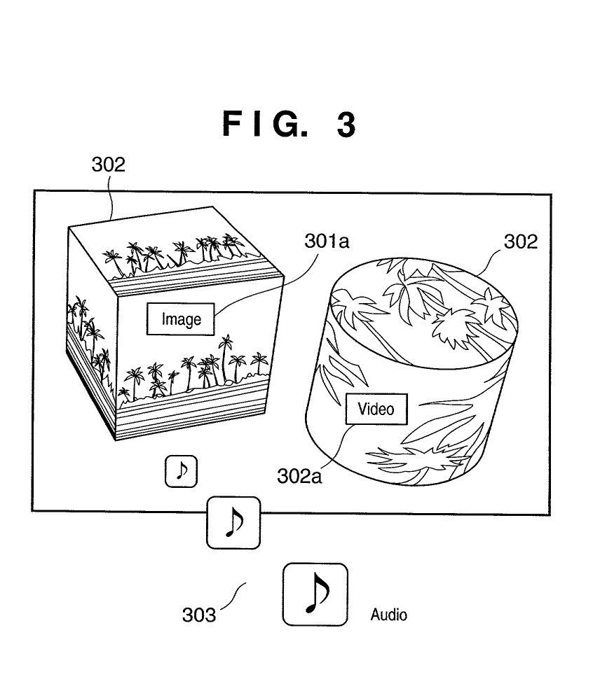

The BIFS encoder 2103 encodes and outputs information of a scene (FIG. 3) composed of media data to be processed by the media encoders 2105.

The IPMP descriptor generator 2102 encodes media data to be processed by the media encoders 2105, and security information, such as copyright information and reproduction conditions, of scene information to be processed by the BIFS encoder 2103. The IPMP descriptor generator 2102 outputs the encoded data as a descriptor (IPMP descriptor) pertaining to IPMP or as IPMP_ES.

The IPMP controller 2104 manages the security information obtained by the IPMP descriptor generator 2102. For example, the IPMP controller 2105 properly encrypts the output encoded media data from the media encoders 2105, or generates and outputs key data necessary for the encryption.

The processing by the IPMP controller 2104 is not limited to the encryption process. For example, a method of embedding security information in uncoded media data is also possible.

The multiplexer 2106 multiplexes the outputs from the OD generator 2101, the IPMP descriptor generator 2102, the BIFS encoder 2103, the IPMP controller 2104, and the media encoders 2105, and outputs one bitstream as shown in FIG. 4 or 5.

The multiplexer 2106 also performs sync control for data to be multiplexed. More specifically, the multiplexer 2106 embeds a time stamp or clock reference into a packet of a bitstream.

The operation of the encoder 2100a as described above completes an SL-packetized bitstream.

To transmit the completed bitstream across, e.g., a network, the encoder 2100a operates as follows.

The selector (demultiplexer) 2107 again demultiplexes the output bitstream from the multiplexer 2106 into, e.g., a bitstream (security bitstream) concerning security such as the IPMP descriptor and IPMP_ES and another bitstream (a bitstream of, e.g., video and audio, to be referred to as a “multimedia stream” hereinafter).

The URL converter 2121 executes processing corresponding to that change in the link relationship between the security bitstream and the multimedia bitstream, which occurs because the selector (demultiplexer) 2107 demultiplexed the bitstream again.

More specifically, the security bitstream and the multimedia bitstream that are linked by ES_ID of IPMP in one bitstream are separated. Therefore, the URL converter 2121 replaces the type number portion with a URL string in the security bitstream.

A method of describing this URL is separately standardized. Although details of the method are not described because it is not directly related to the characteristic feature of this embodiment, the URL can be defined by the ID of a corresponding session.

The multiplexer 2108 again packetizes the security bitstream where necessary in accordance with the URL string conversion information from the URL converter 2121.

The multiplexer 2122 again packetizes, if necessary, the multimedia stream obtained by the selector 2107.

The secure session 2109 transmits the security bitstream from the multiplexer 2108.

The non-secure session 2110 transmits the multimedia bitstream from the multiplexer 2122.

The session manger 2120a sets up optimum sessions for the secure session 2109 and the non-secure session 2110 beforehand.

In the decoder 2100b, on the other hand, the session manger 2120b sets up optimum sessions for the secure session 2109 and the non-secure session 2110 beforehand. The demultiplexer 2111 demultiplexes the IPMP descriptor and IPMP ES from the security bitstream transmitted from the secure session 2109 of the encoder 2100a.

The demultiplexer 2112 demultiplexes the OD, BIFS, and A/V (audio/video) streams from the multimedia bitstream transmitted from the non-secure session 2110 of the encoder 2100a.

The OD parser 2113 extracts the OD information from the OD bitstream obtained by the demultiplexer 2112, and sets each information necessary for the decoder 2100b.

The media decoder 2117 decodes the A/V bitstream (a media stream of, e.g., image, video, and audio) obtained by the demultiplexer 2112.

During the process, the sync controller 2118 synchronizes the various media processed by the media decoder 2117.

The BIFS decoder 2115 decodes the BIFS bitstream obtained by the demultiplexer 2112 and, on the basis of the BIFS information, reconstructs the scene from the diverse media data obtained by the media decoder 2117.

The renderer 2119 properly displays or reproduces each object in accordance with the scene structure obtained by the BIFS decoder 2115.

The IPMP descriptor parser 2114 has a copyright management function and controls the media decoder 2117 and the renderer 2119 (e.g., restricts media reproduction and performs effect control) on the basis of the IPMP descriptor and IPMP_ES (e.g., copyright management information) obtained by the demultiplexer 2111.

For example, when data is encrypted, the IPMP descriptor parser 2114 decrypts the data and transfers the decrypted data to the media decoder 2117. When copyright management information is embedded in uncoded media data, the IPMP descriptor parser 2114 extracts the information and uses it in reproduction control.

In this embodiment as described above, the encoder 2100a again extracts security information such as an IPMP descriptor and IPMP_ES (e.g., copyright management information) from a once formed bitstream, and transmits this security information by the secure session 2109. Hence, there is no danger of this security information being peeped by an unauthorized third party.

Accordingly, even when the syntax of an IPMP descriptor and IPMP_ES is defined, the compatibility with the transmission destination can be maintained without lowering the security level.

<Fourth Embodiment>

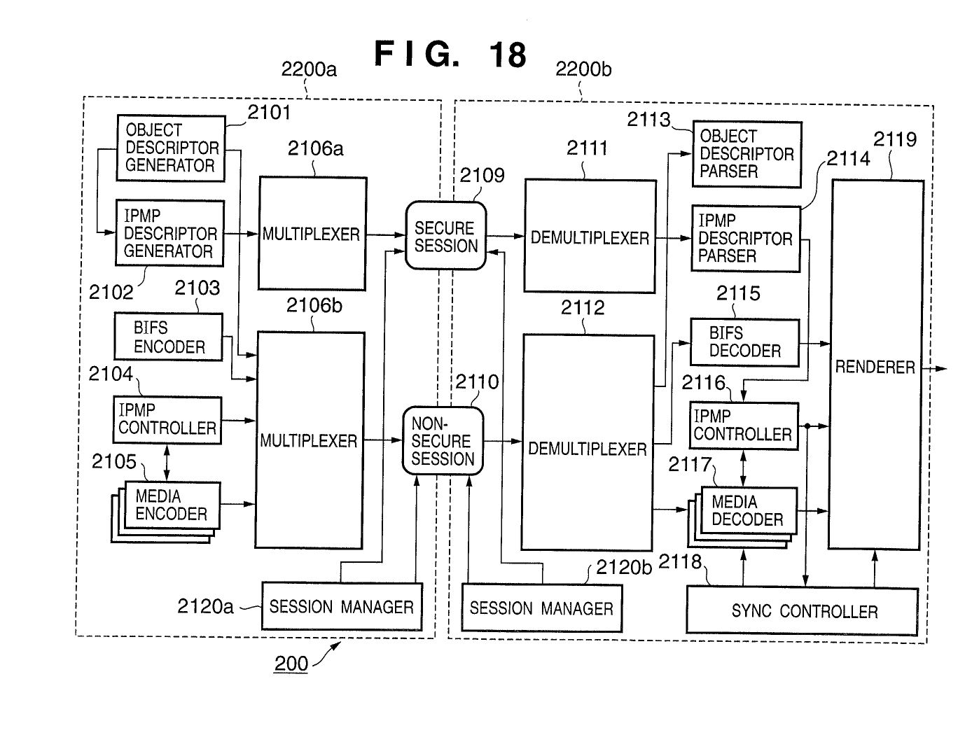

For example, the present invention is applied to a data transmission system 2200 as shown in FIG. 18.

The data transmission system 2200 of this embodiment differs from the data transmission system 2100 shown in FIG. 17 in the following respect of the arrangement.

The same reference numerals as in the data transmission system 2100 of FIG. 17 denote parts having the same functions in the data transmission system 2200 of FIG. 18, and a detailed description thereof will be omitted.

In an encoder 2200a of this embodiment, two multiplexers 2106a and 2106b separately multiplex an IPMP descriptor and IPMP_ES (security information) obtained by an IPMP descriptor generator 2102, and data (media data) obtained by an OD generator 2101, a BIFS encoder 2103, an IPMP controller 2104, and a media encoder 2105. That is, security information is not initially multiplexed but is saved as a different file.

In this embodiment, therefore, the selector 2107, the multiplexers 2108 and 2122, and the URL converter 2121 as shown in FIG. 17 are unnecessary, i.e., it is unnecessary to demultiplex data (security bitstream) which is to be secure and common media data (multimedia bitstream) again. However, if a session is adaptively set up exceptionally, mutual dynamic URL conversion is of course necessary.

Accordingly, even when the syntax of an IPMP descriptor and IPMP_ES is defined, the compatibility with the transmission destination can be maintained with a simple arrangement without lowing the security level.

In each of the third and fourth embodiments, the renderer 2119 should start reproduction or display after security information is transmitted by taking synchronization between sessions.

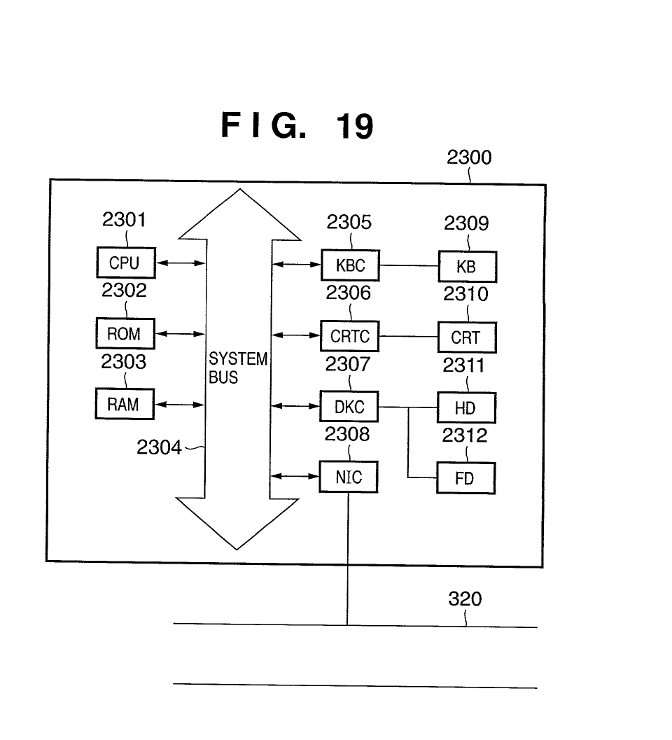

FIG. 19 shows an example of the arrangement of a computer 2300.

As shown in FIG. 19, this computer 2300 includes a CPU 2301, a ROM 2302, a RAM 2303, a keyboard controller (KBC) 2305 of a keyboard (KB) 2309, a CRT controller (CRTC) 2306 of a CRT display (CRT) 2301 as a display unit, a disk controller (DKC) 2307 of a hard disk (HD) 2311 and a floppy disk (FD) 2312, and a network interface card (NIC) 2308 for transmitting data across a network 2320 such as the Internet. These components are communicably connected via a system bus 2304.

The CPU 2301 collectively controls the components connected to the system bus 2304 by executing software stored in the ROM 2302 or the HD 2311 or software supplied from the FD 2312.

That is, the CPU 2301 performs control for practicing the operations of the first and second embodiments described earlier, by reading out and executing a predetermined process program from the ROM 2302, the HD 2311, or the FD 2312.

The RAM 2303 functions as, e.g., a main memory or work area of the CPU 2301.

The KBC 2305 controls instruction inputs from the KB 2309, a pointing device (not shown), and the like.

The CRTC 2306 controls a display of the CRT 2310.

The DKC 2307 controls access to the HD 2311 and the FD 2312 storing a boot program, various applications, edit files, user files, network management programs, and the process programs described above.

The NIC 2308 exchanges data with various devices or systems in tow ways on the network.

In the third and fourth embodiments as explained above, when data containing security information is to be coded and transmitted in accordance with a predetermined standard (e.g., the “ISO/IEC 14496 (MPEG phase 4) standard”), object data (data of, e.g., video and audio) and security information (information such as copyright management information and reproduction conditions) of the object data are transmitted by different sessions.

Since the security information is transmitted by secure session, there is no danger of the security information peeped by an unauthorized third party.

Also, even when the syntax of security information (an IPMP descriptor and IPMP_ES) is defined in transmission based on, e.g., the “ISO/IEC 14496 (MPEG phase 4)” standard, the compatibility with the destination can be kept without lowering the security level.

In the present invention, therefore, secure multimedia transmission is possible while the compatibility is maintained by specifying security information.

In each of the above embodiments, each processing unit can be implemented by software in practice, although hardware constructing a network and the like are included. That is, the object of the present invention can also be achieved by supplying a storage medium (or recording medium) storing program codes of software for implementing the functions of the above embodiments to a system or an apparatus, and reading out and executing the program codes stored in the storage medium by a computer (or a CPU or MPU) of the system or apparatus. In this case, the program codes read out from the storage medium implement the functions of the above embodiments, and the storage medium storing these program codes constitutes the present invention.

Furthermore, besides the functions of the above embodiments are implemented by executing the readout program codes by the computer, the present invention includes a case where an OS (Operating System) or the like running on the computer performs part or the whole of actual processing in accordance with designations by the program codes and thereby implements the functions of the above embodiments.

The present invention also includes a case where, after the program codes read out from the storage medium are written in a memory of a function extension card inserted into the computer or of a function extension unit connected to the computer, a CPU or the like of the function extension card or function extension unit performs part or the whole of actual processing in accordance with designations by the program codes and thereby implements the functions of the above embodiments.

As many apparently widely different embodiments of the present invention can be made without departing from the spirit and scope thereof, it is to be understood that the invention is not limited to the specific embodiments thereof except as defined in the claims.

What is claimed is:

1. A multimedia data transmitting apparatus for transmitting multimedia data composed of a plurality of objects, comprising:
input means for inputting, as a bitstream, multimedia data to which intellectual property protection management data is added;
demultiplexing means for demultiplexing the multimedia data of the input bitstream into the intellectual property protection management data and other media data;
link information updating means for updating link information for linking the intellectual property protection management data and the media data; and
session managing means for managing a non-secure session for transmitting the media data and a secure session for transmitting the intellectual property protection management data.

2. The apparatus according to claim 1, wherein said session managing means sets, in the intellectual property protection management data, a session information data set containing an identifier which indicates that the data is secure.

3. The apparatus according to claim 1, wherein the multimedia data is MPEG-4 format data.

4. A multimedia data receiving apparatus for receiving multimedia data, comprising:
first receiving means for receiving media data by a non-secure session;
second receiving means for receiving, by a secure session, intellectual property protection management data for protecting and managing an intellectual property with respect to the media data;
session managing means for managing the non-secure session and the secure session;
first processing means for demultiplexing media data, which is received by said session managing means via the non-secure session, into media streams, and decoding the media streams;
second processing means for decoding intellectual property protection management data received by said session managing means via the secure session; and
reproducing means for performing reproduction on the basis of the data decoded by said first and second processing means.

5. A multimedia data transmitting method of transmitting multimedia data composed of a plurality of objects, comprising:
the input step of inputting, as a bitstream, multimedia data to which intellectual property protection management data is added;
the demultiplexing step of demultiplexing the multimedia data of the input bitstream into the intellectual property protection management data and other media data;
the link information updating step of updating link information for linking the intellectual property protection management data and the media data; and
the session managing step of managing a non-secure session for transmitting the media data and a secure session for transmitting the intellectual property protection management data.

6. A storage medium storing program codes corresponding to the steps according to claim 5.

7. A multimedia data receiving method of receiving multimedia data, comprising:
the first receiving step of receiving media data by a non-secure session;
the second receiving step of receiving, by a secure session, intellectual property protection management data for protecting and managing an intellectual property with respect to the media data;
the session managing step of managing the non-secure session and the secure session;
the first processing step of demultiplexing media data, which is received in the session managing step via the non-secure session, into media streams, and decoding the media streams;
the second processing step of decoding intellectual property protection management data received in the session managing step via the secure session; and
the reproducing step of performing reproduction on the basis of the data decoded by said first and second processing means.

8. A storage medium storing program codes corresponding to the steps according to claim 7.

9. A multimedia data transmitting apparatus for transmitting multimedia data composed of a plurality of objects, comprising:
input means for inputting media data and intellectual property protection management data for protecting and managing the intellectual property of the media data; and
session managing means for managing a non-secure session for transmitting the media data and a secure session for transmitting the intellectual property protection management data.

10. The apparatus according to claim 9, wherein said session managing means sets, in the intellectual property protection management data, a session information data set containing an identifier which indicates that the data is secure.

11. The apparatus according to claim 9, wherein the multimedia data is MPEG-4 format data.

12. A multimedia data transmitting method of transmitting multimedia data composed of a plurality of objects, comprising:
the input step of inputting multimedia data and intellectual property protection management data for protecting and managing the intellectual property of the multimedia data; and
the session managing step of managing a non-secure session for transmitting the multimedia data and a secure session for transmitting the intellectual property protection management data.

13. A storage medium storing program codes corresponding to the steps according to claim 12.

14. A multimedia data transmission system for transmitting multimedia data composed of a plurality of objects, comprising:
input means for inputting, as a bitstream, multimedia data to which intellectual property protection management data is added;
demultiplexing means for demultiplexing the multimedia data of the input bitstream into the intellectual property protection management data and other media data;
link information updating means for updating link information for linking the intellectual property protection management data and the media data;
session managing means for managing a non-secure session for transmitting the media data and a secure session for transmitting the intellectual property protection management data;
first processing means for demultiplexing media data, which is transmitted via the non-secure session, into media streams, and decoding the media streams;
second processing means for decoding intellectual property protection management data received via the secure session; and
reproducing means for performing reproduction on the basis of the data decoded by said first and second processing means.

15. A multimedia data transmission system for transmitting multimedia data composed of a plurality of objects, comprising:
input means for inputting multimedia data and intellectual property protection management data for protecting and managing the intellectual property of the media data;
session managing means for managing a non-secure session for transmitting the media data and a secure session for transmitting the intellectual property protection management data;
first processing means for demultiplexing media data, which is transmitted via the non-secure session, into media streams, and decoding the media streams;
second processing means for decoding intellectual property protection management data received via the secure session; and
reproducing means for performing reproduction on the basis of the data decoded by said first and second processing means.

16. A data processing apparatus for encoding data containing security information in accordance with a predetermined coding standard, and transmitting the encoded data, comprising:
first encoding means for encoding object data;
second encoding means for encoding security information of the object data;
generating means for generating transmission data from the encoded data obtained by said first and second encoding means;
demultiplexing means for demultiplexing the transmission data obtained by said generating means into security information transmission data and object data transmission data;
first transmitting means for transmitting, by a first session, the security information transmission data obtained by said demultiplexing means; and
second transmitting means for transmitting, by a second session, the object data transmission data obtained by said demultiplexing means.

17. A data processing apparatus for encoding data containing security information in accordance with a predetermined coding standard, and transmitting the encoded data, comprising:
first encoding means for encoding object data;
second encoding means for encoding security information of the object data;
first transmitting means for transmitting, by a first session, transmission data for the encoded data obtained by said first encoding means; and
second transmitting means for transmitting, by a second session, transmission data for the encoded data obtained by said second encoding means.

18. The apparatus according to claim 16, wherein said first encoding means comprises security adding means for adding security to object data.

19. The apparatus according to claim 16, wherein
the first session includes a non-secure session, and
the second session includes a secure session.

20. The apparatus according to claim 16, further comprising decoding means for decoding the object data and the security information from the data transmitted by said first and second transmitting means.

21. The apparatus according to claim 16, wherein the predetermined coding standard is an MPEG-4 coding standard.

22. The apparatus according to claim 21, wherein the security information is IPMP data.

23. A data processing apparatus for receiving and decoding arbitrary data encoded in accordance with a predetermined coding standard and security information of the arbitrary data, the arbitrary data and the security information being transmitted by different sessions.

24. A data processing system in which a plurality of devices are communicably connected, wherein at least one of said plurality of devices has a function of the data processing apparatus according to claim 1.

25. A data processing system for transmitting multimedia data in accordance with a predetermined coding standard, comprising:
at least one first encoding means for encoding media data containing data of at least one of image, video, and audio;
second encoding means for encoding information of a scene constructed of the media data;
third encoding means for encoding attribute information of the media data;
fourth encoding means for encoding security information of the media data;
first forming means for multiplexing all the encoded data obtained by said first to fourth encoding means to form one bitstream;
demultiplexing means for demultiplexing the bitstream obtained by said first forming means into the security information encoded data obtained by said fourth encoding means, and the encoded data obtained by said first to third encoding means;
second forming means for forming the two encoded data obtained by said demultiplexing means into one bitstream again;
link information updating means for updating link information for linking the two encoded data obtained by said demultiplexing means;
transmitting means for transmitting, by first and second different sessions, the two bitstreams obtained by said second forming means;
session control means for setting up two, secure and non-secure sessions for said transmitting means;
third forming means for demultiplexing the encoded data obtained by said first to third encoding means from the bitstream transmitted by the first session by said transmitting means;
fourth forming means for demultiplexing the security information encoded data obtained by said fourth encoding means from the bitstream transmitted by the second session by said transmitting means;
first decoding means for decoding the media data encoded data obtained by said third forming means;
second decoding means for decoding the scene information encoded data obtained by said third forming means to reconstruct the scene;
third decoding means for decoding the media data attribute information encoded data obtained by said third forming means;
fourth decoding means for decoding the security information encoded data obtained by said fourth forming means;
reproducing means for reproducing the data obtained by said first to third decoding means; and
reproduction control means for controlling the reproduction by said reproducing means on the basis of the security information obtained by said fourth decoding means.

26. The system according to claim 25, wherein said first encoding means comprises security adding means for adding security to the media data.

27. The system according to claim 25, wherein the predetermined coding standard is an MPEG-4 coding standard.

28. The system according to claim 27, wherein the security information is IPMP data.

29. A data processing method of encoding and transmitting data containing security information in accordance with a predetermined coding standard, comprising:
the generation step of generating transmission data from encoded data of object data and encoded data of security information of the object data;
a demultiplexing step of demultiplexing the transmission data obtained in the generation step into security information transmission data and object data transmission data; and
the transmission step of transmitting, by different sessions, the two transmission data obtained in the demultiplexing step.

30. The method according to claim 29, wherein the generation step comprises the security addition step of adding security to the object data.

31. A data processing method of encoding and transmitting data containing security information in accordance with a predetermined coding standard, comprising the transmission step of transmitting encoded data of object data and encoded data of security information of the object data by different sessions.

32. The method according to claim 29, wherein the predetermined coding standard is an MPEG-4 coding standard.

33. The method according to claim 32, wherein the security information is IPMP data.

34. The method according to claim 29, further comprising the decoding step of decoding the object data and the security information from the data transmitted by different sessions in the transmission step.

35. The method according to claim 29, wherein the transmission step comprises the steps of:
transmitting the object data transmission data by a non-secure session; and
transmitting the security information transmission data by a secure session.

36. A storage medium storing a computer program for executing the steps according to claim 29.

37. A storage medium storing a computer program for executing the step according to claim 31.
